(19) United States
(12) Patent Application Publication
(10) Pub. No.: US 2016/0028680 A1
(43) Pub. Date: Jan. 28, 2016

(54) NETWORKED SYSTEM OF INTRODUCTION CONSOLES FOR STIMULATING NEW SOCIAL INTERACTIONS

(71) Applicants: Kevin Michael Granville, Vandling, PA (US); Candace Ada Zaro, Carbondale, PA (US)

(72) Inventors: Kevin Michael Granville, Vandling, PA (US); Candace Ada Zaro, Carbondale, PA (US)

(21) Appl. No.: 14/444,702

(22) Filed: Jul. 28, 2014

(51) Int. Cl. H04L 12/58; G06F 3/0488; H04W 4/14

(52) U.S. Cl. CPC H04L 51/32; H04W 4/14; G06F 3/0488

(57) ABSTRACT

A networked system of introduction consoles for deployment in a public location, such as a bar, restaurant or other public place for the purpose of facilitating networking with or meeting of new people in nearby locations in order to stimulate social interactions like dating includes a network server, a plurality of introduction consoles, and a plurality of discrete personal electronic devices. Each of the introduction consoles are connected to network server through an internal electronic data network while the network server is additionally configured to communicate with external, personal communication devices through the Internet. The consoles take photos and uploads profiles of users to the network server, and additionally enables the review of photos stored on the network server. The network server maintains a database of profiles as well as transmits response and posting activity messages directly to active users.

### BRIEF DESCRIPTION OF THE DRAWINGS

FIG. 1 is a block diagram showing the interface components of an introduction console built in accordance with the present invention.

FIG. 2 is a block diagram showing the components of the networked system of introduction consoles in accordance with the present invention.

FIG. 3 shows a flow chart of the new user operational process of a networked system of introduction consoles in accordance with the present invention.

FIG. 4 shows a flow chart of the user response operational process of a networked system of introduction consoles in accordance with the present invention.

### DETAILED DESCRIPTION OF THE INVENTION

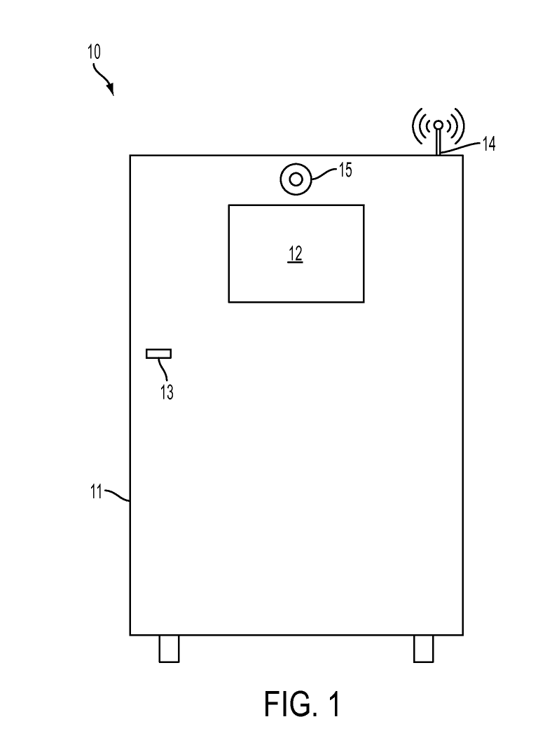

Referring now to the drawings and in particular FIG. 1, an introduction console 10 for stimulating new social interactions is shown having a base housing 11 which includes a display interface, a manual input interface, a data input interface, a networking interface, and photo interface. It is contemplated that the base housing may define a floor standing structure, a wall mounted structure, or a bar top structure. In the preferred embodiment, the display interface and the manual input interface are defined by a conventional touch screen 12 disposed on the housing. It is contemplated, however, that in alternate embodiments, discrete components, such as a conventional display screen and a keyboard, may define the display interface and the manual input interface, respectively.

The data input interface is defined in one embodiment as a Universal Serial Bus (“USB”) receptacle 13. The USB receptacle 13 receives conventional USB jacks to form a bus for connection and communication between the introduction console 10 and external electronic devices, such as a mobile phone (not shown). It is contemplated that in addition to the data input interface, embodiments of the present invention may additionally or alternatively utilize another wire or wireless communication interface to enable connection and communication between the introduction console 10 and external electronic devices, such as a serial data port, a Wi-Fi antenna or a Bluetooth antenna. Specifically, in the preferred embodiment, the data input interface additionally defines a WI-Fi antenna and a Bluetooth antenna housed inside the base housing 11. Each antenna enables a wireless communication device, such as a mobile phone, to communicate data electronically locally (as opposed to over cellular networks or the Internet generally) with the introduction console 10. Through this connectivity, a user can directly transmit log into a system of introduction consoles, either through an app or a web browser, and input a photo and/or user profile data into the system.

In alternate embodiments, the data input interface additionally defines an SMS or MMS receiver, allowing the receipt of photos or user profile information over cellular networks. In addition, it is understood that if the Wi-Fi antenna that enables a connection to the Internet, a system of introduction consoles 10 may be configured to receive data entered on a mobile phone or other remote computer device through an app or web browser that is transmitted over the Internet.

The networking interface is defined in the preferred embodiment as a wireless local area network (“WLAN”) antenna 14. The WLAN (or Wi-Fi) antenna 14 connects the introduction console 10 to an electronic data network within range on the introduction console 10, enabling it to transmit and receive electronic signals with other electronic devices on the electronic data network. In alternate embodiments, the networking interface may be defined as a wired connection or alternate wireless connection to a local area network or a wired or wireless connection to another electronic data network, such as the Internet.

The photo interface defines a conventional image capture device which in the preferred embodiment is an integrated digital camera 15. It is contemplated that the camera 15 may be operated through the manual input interface on the introduction console 10 or from a remote device connected to the introduction console 10 through the WLAN antenna 14.

Internally, the introduction console 10 includes a processor and non-volatile memory, with the non-volatile memory containing instructions that enable the processor to perform its operations, including operate the camera 15 and collect photographs, receive data in the form of manual entries on the manual input interface or transfers through the USB receptacle 13 (or other serial data port, Wi-Fi antenna, or Bluetooth antenna), and communicate data over an electronic data network with other electronic devices.

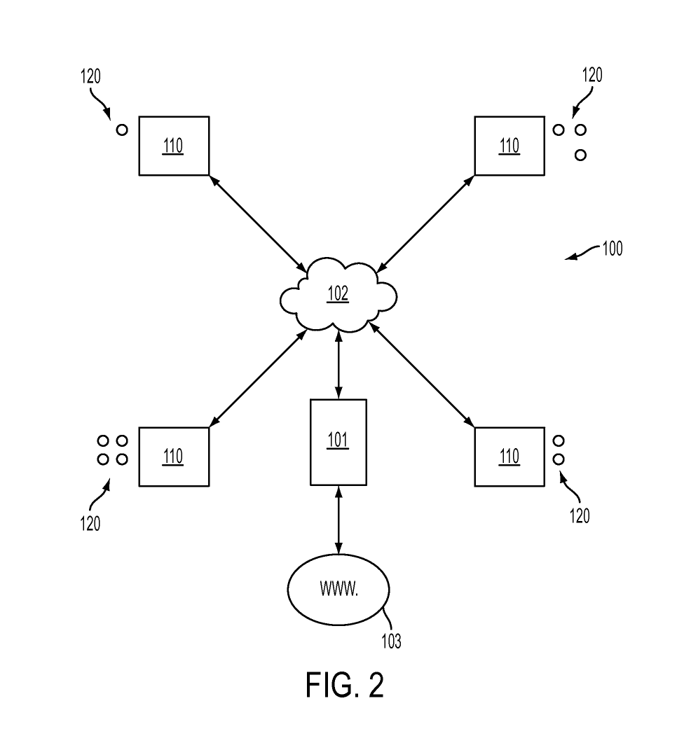

Referring now to FIG. 2, the introduction console is used as one of a plurality of introduction consoles in a single networked system of introduction consoles 100. Such a networked system of introduction consoles 100 includes a network server 101, a plurality of introduction consoles 110, and a plurality of discrete personal electronic devices 120. Each of the introduction consoles 110 can communicate electronic data with the network server 101 through a connection to an internal electronic data network 102. In addition, the network server 101 can communicate with external devices, such as the personal electronic devices 120, through the Internet 103. It is contemplated that the network server 101 utilizes Internet based communication systems such as electronic mail (“email”) protocols, text (or multimedia) messaging protocols, and Voice over Internet Protocol voice or data protocols. In some embodiments, the network server 101 may additionally include components that enable it to communicate over telephone networks, including cellular networks.

It is contemplated that the personal electronic devices 120 define various mobile communication devices, including mobile phones (or cellular phones, smart phones), personal digital assistants, digital cameras (having networking and computing capability) and personal music players (having networking and computing capability). In this regard, the personal electronic devices 120 are operative to receive electronic communications from the network server 101 through the communication protocol available on the device, which may be email, messaging protocols, VoIP, and/or telephone networks, depending on the device.

In operation, the networked system of introduction consoles 100 is deployed in a public location, such as a bar, restaurant or other public place, to take photos of a person or persons in real time, at that specific location, for the purpose of facilitating networking with or meeting new people in nearby locations in order to stimulate social interactions like dating. A particular introduction console 110 is accessed by a user to initiate these social interactions. The user accessing the introduction console 110 begins by either taking a self photo through the photo interface at the introduction console 110 or uploading a photo from a personal electronic device 120 to the introduction console 110 through the data input interface. It is contemplated that while all photos received will be time stamped, uploaded photos will additionally receive a visible marking to enable them to be distinguished by users as not having been taken by one of the introduction consoles 110 (i.e. not verified by the system).

The user then manually enters or uploads contact information that will allow the networked system of introduction consoles 100 to send electronic messages to the user's personal electronic device 120. It is understood that the collection of such information from the user, which may be embodied as an email or mobile phone number, is necessary in order to inform users that someone has responded to their photo or when new photos from a nearby console have been added. In some embodiments, such contact information may also be utilized for the purpose of marketing to the user or users.

In addition to contact information, any particular preferences concerning the type of people the user would like to connect with may be entered into and collected by the introduction console 110.

The introduction console 110 then associates the photo with the collected contact information, any collected preferences, a unique id, and a unique console id which identifies the introduction console 110 the information was entered into, forming an active user profile. The active user profile data is then transmitted to the network server 101 over the internal electronic data network 102 and placed in a database stored thereon. Each introduction console 110 in the networked system of introduction consoles 100 operates in this same manner, enabling the network server 101 to populate its database with pertinent information on a plurality of users in nearby locations who are desirous of stimulating social interactions.

From the moment their active user profile is entered on the database on the network server 101 until the lapse of a preset time period, a user can go to any introduction console 110 in that particular networked system of introduction consoles 100 and view the photo and preferences of all active user profiles and, if desired, select an active user profile to respond to for the purpose of meeting that person or persons. In the preferred embodiment, the preset time period is set to twelve (12) hours.

In one embodiment, in addition or in the alternative to interacting with a particular introduction console 110 while physically standing in front of it, a user can interact remotely with the nearest introduction console 110 through the user's personal electronic device 120. The user's personal electronic device 120, which may be embodied as a smart phone is configured to interact remotely with introduction console 110 through an introduction console software application (or app) that can be downloaded and run from the user's smart phone.

To interact with the nearest introduction console 110, the user would first log onto the local WLAN that the networked system of introduction consoles 100 operates on and load the app. The user's specific physical location is determined by the app, typically through a satellite or network positioning system, and the nearest introduction console 110 is determined therefrom. Accordingly, it is contemplated that if the user is in a bar, the app will allow the user to sign in to the introduction console 110 at that bar. Once logged in, the app allows the user to bring up a map that has the locations of the introduction console 110 in the networked system of introduction consoles 100 in addition to allowing the user to perform the actions listed herein that the user is able to perform while physically in front of a particular introduction console 110.

To accomplish this, the app enables the user's personal electronic device 120 to be associated with the nearest introduction console 110 as viewed by the network server 101. Effectively it says the user using this app is active in the network through ″ introduction console 110 “X” and treats all activity to and from the personal electronic device 120 on which the app is running as if it originated at the associated introduction console 110, similar to how jukeboxes may be controlled in the bar with prior art software applications.

Responses are initiated either through the introduction console 110 or through the mobile phone of a user who has downloaded the app or logged in on a web browser so as to enables communication with the system of introduction consoles 100, and when a user initiates a response to a selected active user profile, the introduction console 110 transmits a command to the network server 101 which causes the network server to send a response message to the personal electronic device 120 associated with the selected active user profile. In the preferred embodiment, the response message includes the photo and the console id associated with the active user account initiating the response message. In alternate embodiments, some combination the contact information, console id, and photo associated with the active user account initiating the response message are included in the response message. Through the provision of this information, the user to whom the response message is directed can make contact with the sender if desired.

Each time the network server 101 receives a new active user profile from one of the introduction consoles 110, it generates a posting message that notifies all other active users that a new active user profile has been entered by transmitting an electronic notification over the Internet 103. In addition, the network server 101 automatically removes the photo associated with an active user profile after twelve (12) hours from the time they were posted and designates the user profile as inactive.

All of the subsequent notification and interaction functions available to be performed on a particular introduction console 110 would additionally be operative through the app. Thus, a user could be notified if someone has responded to the user's photo through the app. The user can initiate a response to other people's photos through the app. A user can communicate directly with people in the network, like sending them a message through the app. A user can invite other users their location, or receive invitations to go to where the other user are through the app. As such, the app effectively works like a chatroom where people have known and defined locations in public areas, like restaurants, bars, festivals, etc.

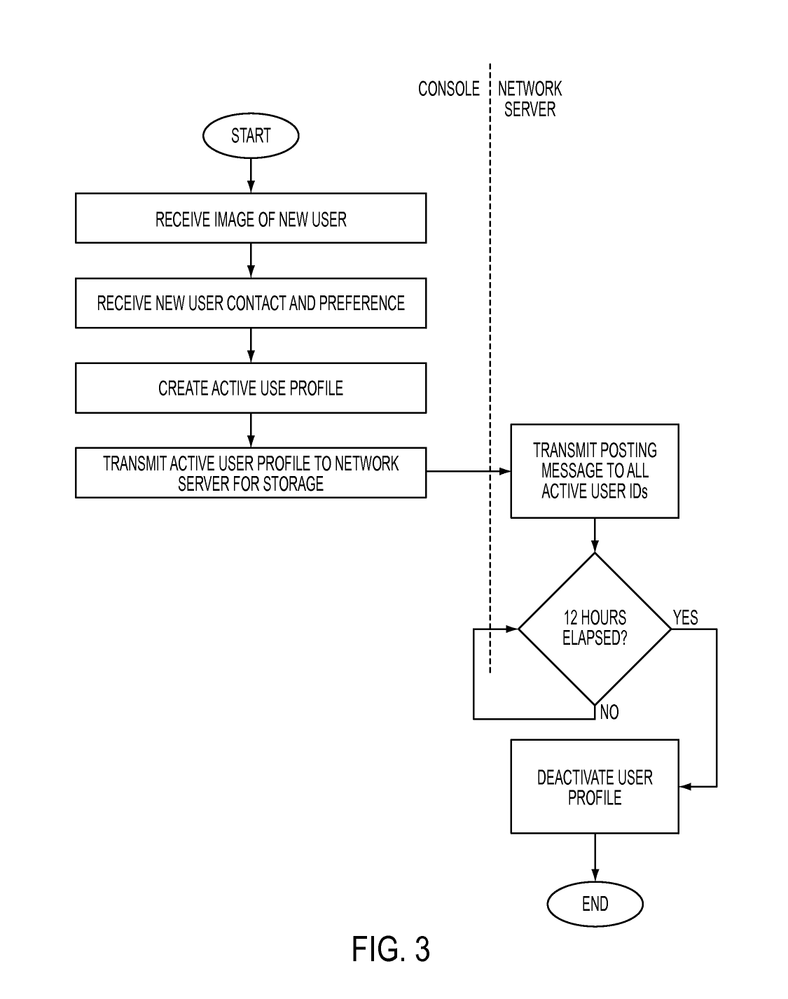

Referring now to FIG. 3, the process by which the networked system of introduction consoles builds and maintains its database of active user profiles begins when a user approaches an introduction console in a particular networked system of introduction consoles and provides their photo. As discussed above, the photo may be captured by a camera on the introduction console or entered through the data input interface on the introduction console. Once the photo is received, the introduction console accepts the contact information for the user, as well as any desired preferences of the type of people that they seek to connect with. The introduction console then creates an active user profile by associating the photo with the collected contact information, any collected preferences, a unique user id, and the console's console id.

Once an active user profile is created, electronic data defining the active user profile is transmitted to the network server for storage in a relational database. As the central hub of the networked system of introduction consoles, the network server will receive active user profile data from all of the introduction consoles and maintain the database in which the active user profile data is kept.

In addition to storing the active user profile data, the network server transmits a posting message to the contact information of all active user profiles in the database. This posting message notifies all users with an active user profile in the particular networked system of introduction consoles that a new user has been entered and that a new photo is available to be viewed at any one of the introduction consoles.

As part of the ongoing maintenance of the database, the network server also runs a query periodically to check if there are any active user profiles which have been on the database for more than twelve (12) hours. If any active user profiles older than that are discovered, the network server deactivates the user profile and deletes the photo associated therewith. It is contemplated that when deactivating a user profile, the network server may delete the profile on in whole or in part, or simply remove an active designation therefrom. If an active designation is removed therefrom, the user profile may be subsequently reactivated if requested by the corresponding user.

It is contemplated that in alternate embodiments, the twelve (12) hour period can be any designated period of time, as selected by an administrator of the networked system of introduction consoles.

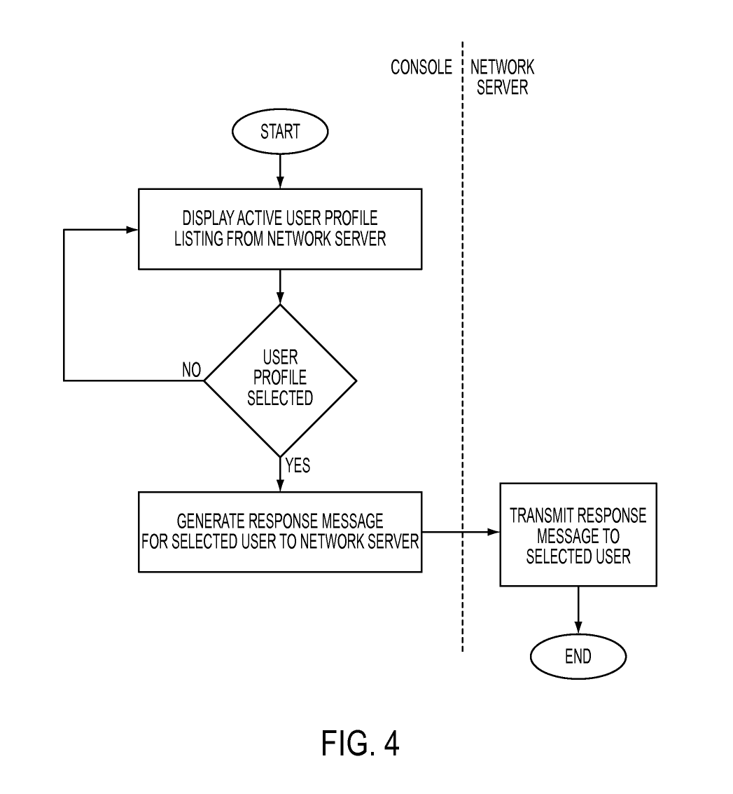

Referring now to FIG. 4, the process of facilitating a social interaction between users that each have an active user profile in the networked system of introduction consoles begins with a user interfacing with one of the introduction consoles in a particular networked system of introduction consoles to review a listing of active user profiles displayed on the introduction console. It is contemplated that in some embodiments, the listing of active user profiles may also include and be sorted by the introduction console on which it was entered, a thumbnail of the photo, the time it was entered, and/or the preferences associated therewith.

In the preferred embodiment, network server provides cloud based access to database, with the data displayed in this listing being retrieved in real time from the network server. The listing includes in the preferred embodiment a sequential listing of each photo associated with an active user profile at that moment. In alternate embodiments, the all active user profile data in the database may be retrieved periodically by and stored on the introduction console for displaying locally.

Once a user selects a particular active user profile to review, the introduction console generates the response message to be transmitted to the contact information associated with the selected active user profile. In the preferred embodiment, the user can customize the response message to include at least one of the responding user's photo, a personalized greeting, and/or the introduction console from which the response message is being generated. After the response message is generated, a transmission to the contact information associated with the selected active user profile is sent for delivery to the personal electronic device of the selected user. At that point, the selected user can selectively respond through their personal electronic device, an introduction console, or by approaching the sender, or simply ignore the response message.

The present invention has been shown and described herein in what is considered to be the most practical and preferred embodiment. It is recognized, however, that departures may be made therefrom within the scope of the invention and that obvious modifications will occur to a person skilled in the art.

What is claimed is:

1. An introduction console for deployment in a public location to facilitate social interactions between strangers, comprising:
a console housing;
a camera integral with said console housing, wherein said camera is configured to capture user images;
at least one of a touch screen and a key pad integral with said console housing, wherein said at least one of a touch screen and a key pad enables user profile data to be entered into said introduction console;
a display interface integral with said console housing, wherein said display interface is operative to enable display user images and user profile data;
a networking interface integral with said console housing, wherein said networking interface enables said introduction console to communicate user images and user profile data over an electronic data network; and
wherein said introduction console is configured to associate each user photo captured with the user profile data received therewith, a unique console identifier relating to the introduction console, and a unique user identifier.

2. The introduction console of claim 1, wherein user profile data is defined as any contact information and any user preferences input into said at least one of a touch screen and a key pad.

3. The introduction console of claim 1, additionally comprising a data input interface integral with said console housing, wherein said data input interface is operative to form a bus for connection and communication between the introduction console and an external electronic device, thereby enabling the receipt of at least one of transmitted user photos and transmitted user profile data.

4. The introduction console of claim 3, wherein said introduction console is additionally configured to associate each transmitted user photo received through the data input interface with the user profile data received therewith.

5. The introduction console of claim 1, wherein said networking interface enables said introduction console to communicate with a network server.

6. The introduction console of claim 5, wherein said introduction console transmits user images and user profile data once associated with the unique console identifier and the unique user identifier.

7. The introduction console of claim 5, wherein said display interface is operative to display user images and user profile data stored on said network server.

8. A networked system of introduction consoles, comprising:
a plurality of introduction consoles, each connected to a first electronic data transfer network, wherein each of said introduction consoles includes a camera configured to capture user images, a at least one of a touch screen and a key pad configured to enable the entry of user profile data, and a display interface operative to display user images and user profile data;
a network server connected to said first electronic data transfer network and a second electronic data transfer network, wherein said network server is configured to transmit electronic signals to external communication devices through said second electronic data transfer network; and
wherein each of said introduction consoles are configured to create and transmit to said network server a user profile by associating one user photo captured with the user profile data received therewith, a unique console identifier relating to the introduction console, and a unique user identifier.

9. The networked system of introduction consoles of claim 8, wherein said display interface is operative to display user images and user profile data stored on said network server.

10. The networked system of introduction consoles of claim 8, wherein said network server is additionally configured to store user profiles in relational database.

11. The networked system of introduction consoles of claim 10, wherein said network server is additionally configured delete, at least in part, stored user profiles twelve hours after receiving them.

12. The networked system of introduction consoles of claim 8, wherein said introduction consoles additionally include a data input interface operative to form a bus for connection and communication between the introduction console and an external electronic device, thereby enabling the receipt of at least one of transmitted user photos and transmitted user profile data.

13. The networked system of introduction consoles of claim 12, wherein said introduction consoles are additionally configured to associate each transmitted user photo received through the data input interface with the user profile data received therewith.

14. The networked system of introduction consoles of claim 12, wherein each of said introduction consoles are configured to include an visual indication on transmitted user photos received which visually identifies them as not being captured by the camera of one of said introduction consoles.

15. The networked system of introduction consoles of claim 8, wherein user profile data is defined as any contact information and any user preferences input into said at least one of a touch screen and a key pad.

16. The networked system of introduction consoles of claim 15, wherein each of said introduction consoles are configured to generate a response message directed to a user profile stored on said network server.

17. The networked system of introduction consoles of claim 16, wherein said network server transmits said response message to the contact information associated with the user profile to which the response message is directed when generated by one of said introduction consoles, enabling the delivery of the response message to an external communication device.

18. The networked system of introduction consoles of claim 16, wherein the response message includes a photo and the console id associated with one user profile on the network server.

19. The networked system of introduction consoles of claim 16, wherein the response message includes at least one of the contact information, console id, and photo associated with one user profile on the network server.

20. The networked system of introduction consoles of claim 8, wherein said network server transmits a posting message to external communication devices when a user profile is received from one of said introduction consoles.
